(19) United States
(12) Patent Application Publication
(10) Pub. No.: US 2011/0240863 A1
(43) Pub. Date: Oct. 6, 2011

(54) METHODS AND APPARATUSES FOR MEASURING PHASE ROUGHNESS IN AN EXTREME ULTRAVIOLET MASK

(76) Inventors: Dong-gun Lee, Hwaseong-si (KR); Seong-sue Kim, Seoul (KR)

(21) Appl. No.: 12/984,856

(22) Filed: Jan. 5, 2011

(30) Foreign Application Priority Data
Apr. 1, 2010 (KR) 10-2010-0029975

(51) Int. Cl. G01N 21/17

(52) U.S. Cl. 250/358.1

(57) ABSTRACT

Example embodiments are directed to a method and an apparatus for measuring phase roughness in an extreme ultraviolet (EUV) mask. In example embodiments, a speckle generated by the phase roughness in the EUV mask is detected by irradiating an EUV beam on the EUV mask. The phase roughness in the EUV mask is calculated and measured using the speckle.

### CROSS-REFERENCE TO RELATED APPLICATIONS

This application claims priority under 35 U.S.C. §119 to Korean Patent Application No. 10-2010-0029975, filed on Apr. 1, 2010, in the Korean Intellectual Property Office, the disclosure of which is incorporated herein in its entirety by reference.

### BACKGROUND

Example embodiments of the inventive concepts relate to a photomask used in a lithography process, and more particularly, to methods and apparatuses for measuring phase roughness in an extreme ultraviolet (EUV) mask.

Mask patterns are formed in a photomask on a substrate for wed of a transparent material. Light (a beam) passes through (is exposed to) the photomask having the mask patterns and then transferred to a wafer (a semiconductor substrate), thereby forming a desired pattern on the wafer. This process is referred to as a lithography process. As design rules are reduced for high integration in processes of manufacturing a semiconductor device, a lithography process having higher resolution is performed. A deep ultraviolet lithography (DUVL) process is performed to form patterns having a critical dimension (CD) of about 250 nm by using a KrF laser having a 248 nm-wavelength as a light source. Also, if the DUVL uses an ArF laser having a 193 nm-wavelength as a light source, patterns having a CD from about 100 nm to about 13 nm may be formed.

However, the DUVL process is limited in obtaining resolution of 100 nm or less. Therefore, an extreme ultraviolet lithography (EUVL) process, which uses extreme ultraviolet (EUV) rays having a wavelength shorter than that of a KrF or ArF laser as a light source is used. If EUV rays are used as a light source, the EUV rays are absorbed into most of materials. Thus, it is difficult for the EUV rays to be used in a current exposure method using transmission. In other words, a transmissive photomask used in a DUVL process cannot be used in an EUVL process. Thus, an EUV mask, which is a reflective photomask, is used in the EUVL process.

The EUV mask has surface roughness. If light is incident on the EUV mask having the surface roughness through an exposure process, phase roughness, which causes a change in a phase of the light, occurs in the EUV mask. In particular, since the EUV mask is a reflective photomask, it is necessary to measure the phase roughness in the EUV mask.

### SUMMARY

According to example embodiments of the inventive concepts, a method of measuring phase roughness in an extreme ultraviolet (EUV) mask includes irradiating an EUV beam on the EUV mask to detect at least one speckle generated by the phase roughness in the EUV mask; and determining the phase roughness in the EUV mask based on the detected at least one speckle.

According to example embodiments of the inventive concepts, the method further includes providing the EUV mask, wherein the phase roughness in the EUV mask is due to a phase change in the EUV beam caused by a surface roughness of the EUV mask.

According to example embodiments of the inventive concepts, the method further includes providing the EUV mask, wherein the phase roughness in the EUV mask includes a refractive phase roughness component that is generated by a surface roughness of a capping layer included in the EUV mask and a reflective phase roughness component that is generated by a surface roughness of a substrate of the EUV mask.

According to example embodiments of the inventive concepts, the method further includes providing the EUV mask, wherein the reflective phase roughness component is greater than the refractive phase roughness component.

According to example embodiments of the inventive concepts, determining the phase roughness includes calculating the phase roughness in the EUV mask using a Gerchberg-Saxton (GS) algorithm, the phase roughness being calculated based on the detected at least one speckle.

According to example embodiments of the inventive concepts, the irradiating irradiates the EUV beam at an angle of about 6° with respect to the EUV mask.

According to example embodiments of the inventive concepts, the irradiating irradiates the EUV beam having a center wavelength of about 13.5 nm.

According to example embodiments of the inventive concepts, the method further includes determining a line edge roughness (LER) of a resist pattern formed on a wafer after determining the phase roughness.

According to example embodiments of the inventive concepts, a method of measuring phase roughness in an extreme ultraviolet (EUV) mask includes generating an EUV beam; irradiating the EUV beam on the EUV mask; detecting at least one speckle generated by the phase roughness in the EUV mask based on an EUV beam reflected from the EUV mask; and determining the phase roughness in the EUV mask based on the detected at least one speckle.

According to example embodiments of the inventive concepts, the irradiating irradiates a femtosecond laser on a neon gas cell to obtain the EUV beam.

According to example embodiments of the inventive concepts, the irradiating irradiates the EUV beam having a center wavelength of about 13.5 nm.

According to example embodiments of the inventive concepts, the method further includes providing the EUV mask including a substrate, a reflective layer formed on the substrate, and a capping layer formed on the reflective layer.

According to example embodiments of the inventive concepts, the method further includes providing the EUV mask, wherein the phase roughness in the EUV mask includes a refractive phase roughness component that is generated by a surface roughness of the capping layer and a reflective phase roughness component that is generated by a surface roughness of the substrate.

According to example embodiments of the inventive concepts, determining the phase roughness includes calculating the phase roughness in the EUV mask using a Gerchberg-Saxton (GS) algorithm, the phase roughness being calculated based on the detected at least one speckle.

According to example embodiments of the inventive concepts, the irradiating irradiates the EUV beam at an angle of about 6° with respect to the EUV mask.

According to example embodiments of the inventive concepts, an apparatus of measuring phase roughness in an extreme ultraviolet (EUV) mask includes a light source unit configured to generate an EUV beam; an irradiation unit configured to irradiate the EUV beam on the EUV mask; a detection unit configured to detect at least one speckle generated by the phase roughness in the EUV mask using a reflected EUV beam reflected from the EUV mask; and a processor configured to determine the phase roughness in the EUV mask using the at least one speckle.

According to example embodiments of the inventive concepts, the light source unit includes a femtosecond laser, a focusing lens, and a neon gas cell, wherein the EUV beam is generated by irradiating the femtosecond laser on the neon gas cell through the focusing lens.

According to example embodiments of the inventive concepts, the irradiation unit includes an X-ray mirror and a pinhole unit configured to provide a center wavelength of about 13.5 nm to the EUV beam, wherein the EUV beam is irradiated on the EUV mask through the X-ray mirror and the pinhole unit.

According to example embodiments of the inventive concepts, the X-ray mirror and the pinhole unit are configured to irradiate the EUV beam at an angle of about 6° with respect to the EUV mask.

According to example embodiments of the inventive concepts, the detection unit includes an X-ray charge-coupled device (CCD) and is configured to detect the reflected EUV beam.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a cross-sectional view illustrating an extreme ultraviolet (EUV) mask that may be used in a method of measuring phase roughness, according to example embodiments of the inventive concepts;

FIG. 2 is a cross-sectional view illustrating phase roughness in the EUV mask of FIG. 1;

FIGS. 3 and 4 are cross-sectional views respectively illustrating phase differences caused by heights of surface roughness of a capping layer and a mask substrate of the EUV mask of FIG. 2;

FIG. 5 is a schematic diagram illustrating an apparatus for measuring phase roughness in an EUV mask according to example embodiments of the inventive concepts;

FIG. 6 is a schematic diagram illustrating a path through which EUV beams are incident on and reflected from the EUV mask of FIG. 5;

FIGS. 7 and 8 are diagrams illustrating an intensity of an EUV beam irradiated onto an EUV mask having phase roughness and an intensity of a speckle pattern included in an EUV emitted beam detected by a detection unit;

FIG. 9 illustrates a method of calculating phase roughness in a method of measuring phase roughness, according to example embodiments of the inventive concepts;

FIG. 10 is a flowchart illustrating a process of evaluating resist line edge roughness (LER) caused by phase roughness in an EUV mask, according to example embodiments of the inventive concepts; and

FIG. 11 is a flowchart illustrating a method of measuring phase roughness in an EUV mask according to example embodiments of the inventive concepts.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

FIG. 1 is a cross-sectional view illustrating an extreme ultraviolet (EUV) mask that may be used in a method of measuring phase roughness, according to example embodiments of the inventive concepts.

In more detail, EUV rays used in an extreme ultraviolet lithography (EUVL) process have a wavelength of 13.5 nm as a center wavelength. Most materials have light absorption properties in the center wavelength. Thus, an EUV mask 10 includes a reflective layer 14 that is formed on a mask substrate 12. The EUV mask 10 reflects incident beams during an exposure process.

The mask substrate 12 may be a silicon substrate or a quartz substrate or the like. The reflective layer 14 may be a multilayer film that is formed by alternatively stacking two different types of layers. For example, the reflective layer 14 may be a multilayer film that is formed by alternatively stacking silicon layers and molybdenum layers. In this case, the reflective layer 14 may be a bilayer that is formed of about 40 to 60 silicon layers and about 40 to 60 molybdenum layers. The silicon layers and the molybdenum layers constituting the reflective layer 14 may each have a thickness between about 3 nm and 4 nm.

Absorbent layer patterns 20 are formed above the reflective layer 14 and these absorb EUV beams. Areas of the reflective layer 14, which are exposed through the absorbent layer patterns 20, are defined as reflective areas 22. The absorbent layer patterns 20 may each have a thickness of about 200 nm and may be formed of a tantalum layer, a titanium nitride layer, a titanium layer, or the like. A capping layer 16 is interposed between the absorbent layer patterns 20 and the reflective layer 14. The capping layer 16 may be formed of one material layer or two material layers or a higher number of material layers. The capping layer 16 is formed to protect the reflective layer 14. The capping layer 16 may be formed of a ruthenium layer, for example. Patterns may be formed on a wafer (a semiconductor substrate), e.g., a silicon wafer, by performing an exposure process using the EUV mask 10, which is a reflective photomask.

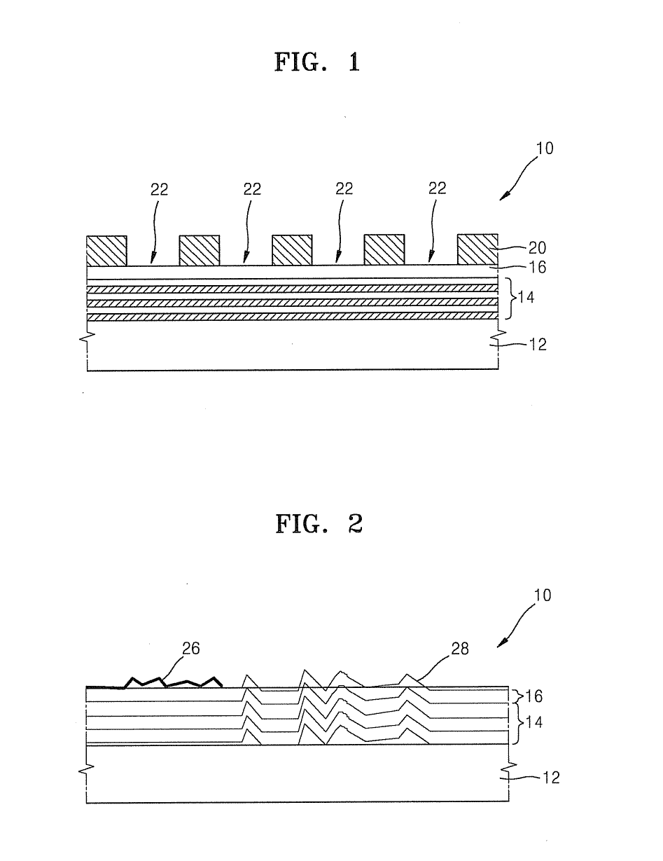

FIG. 2 is a cross-sectional view illustrating phase roughness in the EUV mask 10 of FIG. 1.

In more detail, the absorbent layer patterns 20 are omitted in FIG. 2 for convenience of explanation. Unlike a DUV transmissive mask, the EUV mask 10 is a reflective photomask and thus includes the reflective layer 14 that is a multilayer film and reflects the EUV beams. Therefore, phase roughness in the EUV mask 10 includes a refractive phase roughness component 26 and a reflective phase roughness component 28. The refractive phase roughness component 26 is generated by surface roughness of the capping layer 16 formed to protect the reflective layer 14. The reflective phase roughness component 28 is generated by transferring surface roughness of the mask substrate 12 to a surface of the EUV mask 10 through the reflective layer 14. The refractive phase roughness component 26 is generated by the surface roughness of the capping layer 16 as described above but may be generated by surface roughness of a layer that is positioned higher than the reflective layer 14 if a structure of the EUV mask 10 is changed.

Phase roughness in the DUV transmissive mask has a refractive phase roughness component that is a surface roughness component of a mask substrate. Since the EUV mask 10 includes the reflective layer 14, the EUV mask 10 further has a reflective phase roughness component that is transferred from the surface roughness of the mask substrate 10 positioned underneath the reflective layer 14.

If the phase roughness in the EUV mask 10 including the refractive and reflective phase roughness components 26 and 28 is large, line edge roughness (LER) in a pattern formed on a semiconductor substrate (a wafer) through a lithography process may become large. LER refers to a phenomenon in which an edge of a resist pattern, for example, exhibits minute curvatures. Therefore, the refractive and reflective phase roughness components 26 and 28 are to be measured to pre-estimate the LER.

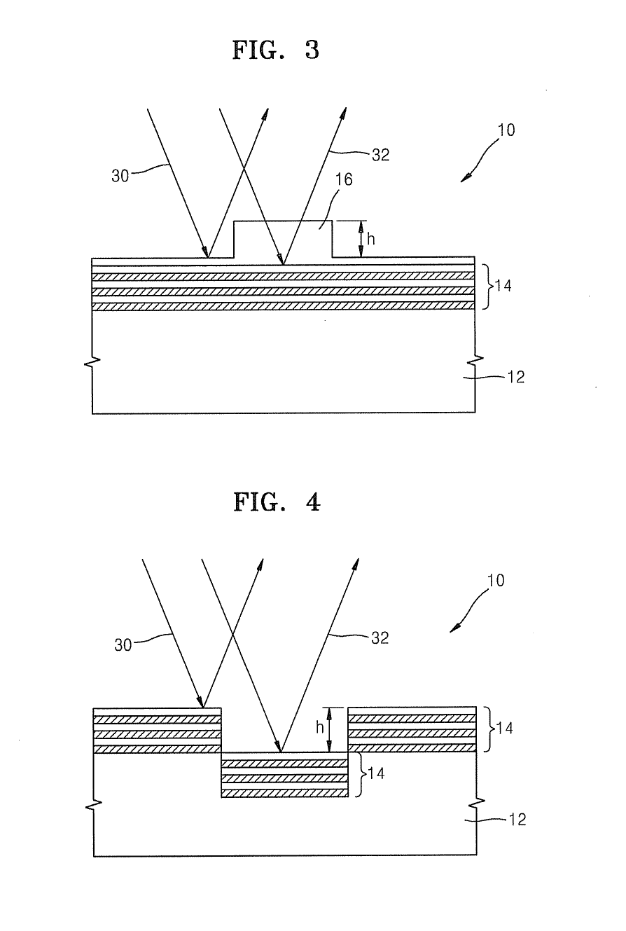

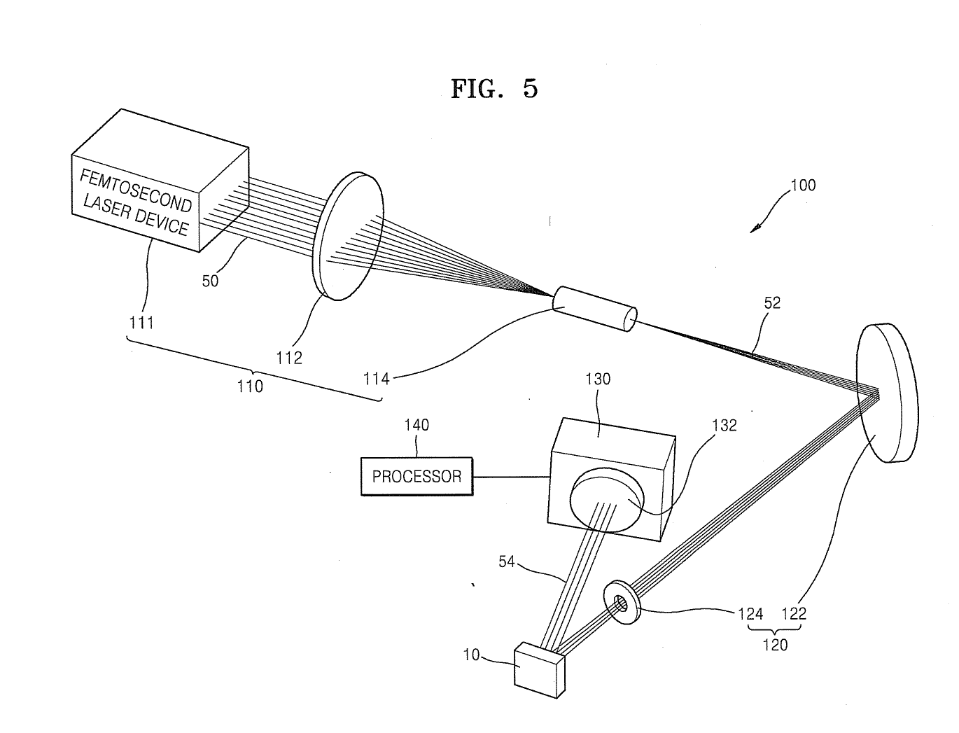

FIGS. 3 and 4 are cross-sectional views respectively illustrating phase differences caused by surface roughness, for example, difference in heights on the capping layer 16 and/or the mask substrate 12 of the EUV mask 10 of FIG. 2.

Referring to FIG. 3, a phase difference occurs due to surface roughness of the capping layer 16 of the EUV mask 10. Reference character “h” in FIG. 3 denotes a height of the surface roughness of the capping layer 16. A phase difference between an incident beam 30 incident on the EUV mask 10 and a reflected beam 32 reflected from the EUV mask 10 is (2π/λ)×2×h×(1−n). Here, “h” is 3.3 nm as the height “h” of the surface roughness of the capping layer 16, “λ” is 13.5 nm as a center wavelength of EUV beams and, and “n” is a refractive index of the capping layer 16. If the capping layer 16 is formed of a ruthenium layer, the refractive index of the capping layer 16 is 0.9. If the phase difference is calculated according to the above conditions, the phase difference caused by the surface roughness of the capping layer 16 of the EUV mask 10 is about 18° (e.g., 17.6°).

Referring to FIG. 4, a phase difference occurs due to surface roughness of the mask substrate 12 of the EUV mask 10. The capping layer 16 is omitted in FIG. 4 for convenience of explanation. When a height of the surface roughness of the mask substrate 12 is “h” as in FIG. 3, a phase difference between an incident beam 30 incident onto the EUV mask 10 and an emitted beam 32 emitted from the EUV mask 10 is (2π/λ)×2×h. Here, “h” is 3.3 nm as the height of the surface roughness of the mask substrate 12, and “λ” is 13.5 nm as a center wavelength of EUV beams. If the phase difference is calculated according to the above conditions, the phase difference caused by the surface roughness of the mask substrate 12 of the EUV mask 10 is about 180° (e.g., 176°).

As described with reference to FIGS. 3 and 4, the phase difference caused by the surface roughness of the capping layer 16 of the EUV mask 10, for example, the refractive phase roughness component 26, is different from the phase difference caused by the surface roughness of the mask substrate 12, i.e., the reflective phase roughness component 28. In particular, the reflective phase roughness component 28 is about 10 times greater than the refractive phase roughness component 26.

In general, source roughness may be measured by an atomic force microscopy (AFM) apparatus. The AFM apparatus measures a height difference of a material layer using a microtip. If the surface roughness of the EUV mask 10 is measured using the AFM apparatus, the refractive and reflective phase roughness components 26 and 28 may not be distinguished from each other. Therefore, surface roughness, for example, the reflective phase roughness component 28, may not be accurately measured by using the AFM apparatus. Also, it is difficult to estimate LER of a pattern formed on a wafer (a semiconductor substrate) through an exposure process, by using the AFM apparatus.

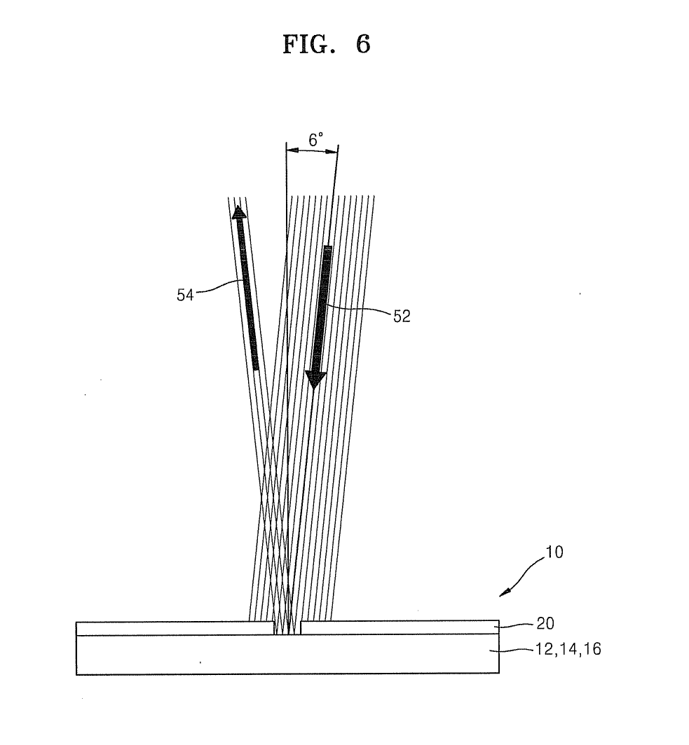

FIG. 5 is a schematic diagram illustrating an apparatus 100 for measuring phase roughness in the EUV mask 10 according to example embodiments of the inventive concepts. FIG. 6 illustrates a path through which EUV beams are incident on and reflected from the EUV mask 10 of FIG. 5.

Referring to FIG. 5, the apparatus 100 includes a light source unit 110, an irradiation unit 120, and a detection unit 130. The light source unit 110 includes a femtosecond laser device 111, a focusing lens 112, and a Neon gas cell 114. A femtosecond means about 10 seconds to about 15 seconds. The femtosecond laser device 111 irradiates femtosecond laser beams 50 on the focusing lens 112. In example embodiments, the femtosecond laser includes a femtosecond titanium and sapphire laser. A correlator is connected to the femtosecond titanium and sapphire laser and thus generates a pulse laser beam having a frequency of several tens of MHz. The femtosecond laser beams 50 pass to the neon gas cell 114 via the focusing lens 112. The femtosecond laser beams pass through a neon gas stored in the neon gas cell 114 and thus generates EUV incident beams 52 having various wavelengths are generated.

The irradiation unit 120 includes an X-ray mirror 122 and a pinhole unit 124. The X-ray mirror 122 is disposed between the neon gas cell 114 and the pinhole unit 124 and irradiates the EUV incident beam 52 having a center wavelength of 13.5 nm on the EUV mask 10. In other words, the X-ray mirror 122 selects the EUV incident beam 52 having the center wavelength of 13.5 nm and irradiates the selected EUV incident beam 52 on the EUV mask 10. Although, the X-ray mirror 122 is used herein, example embodiments are not limited thereto and a filter or the like that may select a center wavelength may be used.

The pinhole unit 124 is disposed between the X-ray mirror 122 and the EUV mask 10, irradiates some of the EUV incident beams 52, which are then irradiated on the EUV mask 10. The pinhole unit 124 also reduces an area of the EUV incident beams 52 that are irradiated on the EUV mask 10 and irradiates the EUV incident beams 52 having a reduced area on the EUV mask 10.

The EUV incident beams 52 are irradiated on the EUV mask 10 at an angle of about 6° with respect to the EUV mask 10. EUV emitted beams 54 emitted/reflected from the EUV mask 10 may be obtained more efficiently than when the EUV incident beams 52 are inclined with respect to the EUV mask 10 at the angle of 6° in example embodiments. The detection unit 130 includes a detection device that detects EUV beams, for example, an X-ray charge-coupled device (CCD) 132. The X-ray CCD 132 receives the EUV emitted beams 54 that have been irradiated on, diffused by, interfered with, reflected from, and/or diffracted from the EUV mask 10.

The apparatus 100 further includes a processor 140 that calculates and measures phase roughness in the EUV mask 10 by using speckles, as will be described later. The processor 140 may be connected to the detection unit 130.

A method of measuring phase roughness by using the apparatus 100 of FIG. 5 will now be described. Speckles included in the EUV emitted beams 54 are formed by selectively reducing an irradiation area of the EUV incident beams 52 irradiated on the EUV mask 10 using the pinhole unit 124 and improving spatial coherence of the EUV incident beams 52. The EUV incident beams 52 that have been irradiated on the EUV mask 10 and have high spatial coherence are emitted/reflected as the EUV emitted beams 54 having phase roughness caused by surface roughness of the EUV mask 10. Since the EUV emitted beams 54 are coherent with one another while travelling to the X-ray CCD 132, the speckles are formed on the X-ray CCD 132. The speckles refer to spot-like shapes that are formed in diffraction patterns of the EUV emitted beams 54 and random positions. The speckles refer to random intensity patterns that are generated due to coherence between a series of wave fronts and random patterns that are generated when EUV beams are incident on a rough surface. The speckles are generated by phase roughness in an EUV mask.

Therefore, according to example embodiments, the EUV beams 52 having high coherence are irradiated on a surface of the EUV mask 10 to be measured. Also, the EUV emitted beams 54 emitted/reflected from the EUV mask 10 are detected by the detection unit 130 and the X-ray CCD 132, and the speckles having the diffracted patterns are analyzed. Thus, the phase roughness in the EUV mask 10 that causes the speckles may be calculated.

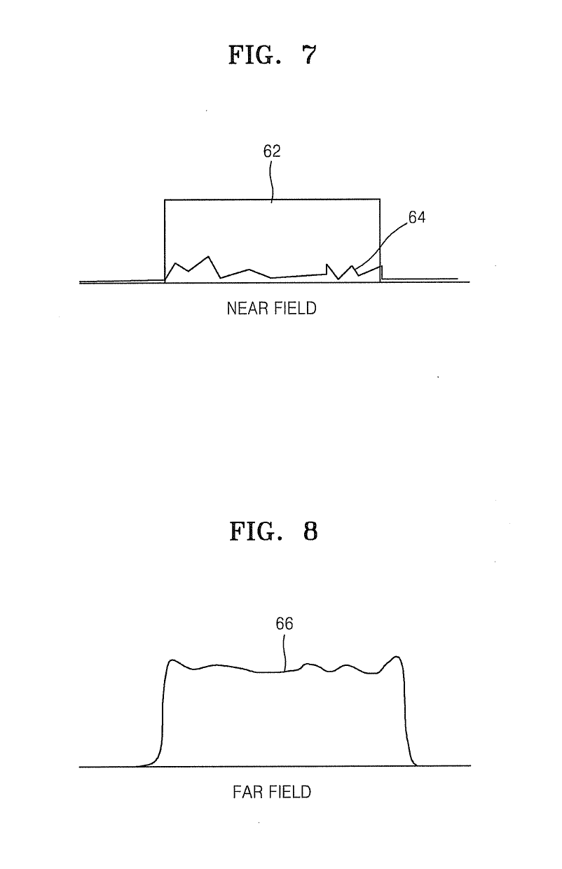

FIGS. 7 and 8 are diagrams respectively illustrating an intensity of an EUV beam irradiated on an EUV mask having phase roughness and an intensity of a speckle pattern included in an EUV emitted beam detected by a detection unit.

In more detail, FIG. 7 illustrates the intensity of the EUV beam irradiated on the EUV mask in a near field. In other words, FIG. 7 illustrates an intensity 62 of an EUV beam (an incident beam) irradiated on the EUV mask 10 having phase roughness 64. FIG. 8 illustrates the intensity of the EUV emitted beam detected by the detection unit, for example, by an X-ray CCD in a far field. In other words, FIG. 8 illustrates an intensity 66 of a speckle pattern included in the EUV emitted beam 54 detected by the detection unit 130. Dented parts of an intensity line in FIG. 8 may be regarded as parts corresponding to speckles.

If the EUV beam 52 is irradiated on the EUV mask 10 having the phase roughness 64, the EUV beam 52 is diffused and reflected from the EUV mask 10, and thus the EUV emitted beam 54 diffused and reflected from the EUV mask 10 has a phase of the phase roughness 64. If the EUV emitted beam 54 having the phase of the phase roughness 64 travels to the X-ray CCD 132, the EUV emitted beam 54 has an intensity of a speckle pattern as shown in FIG. 8.

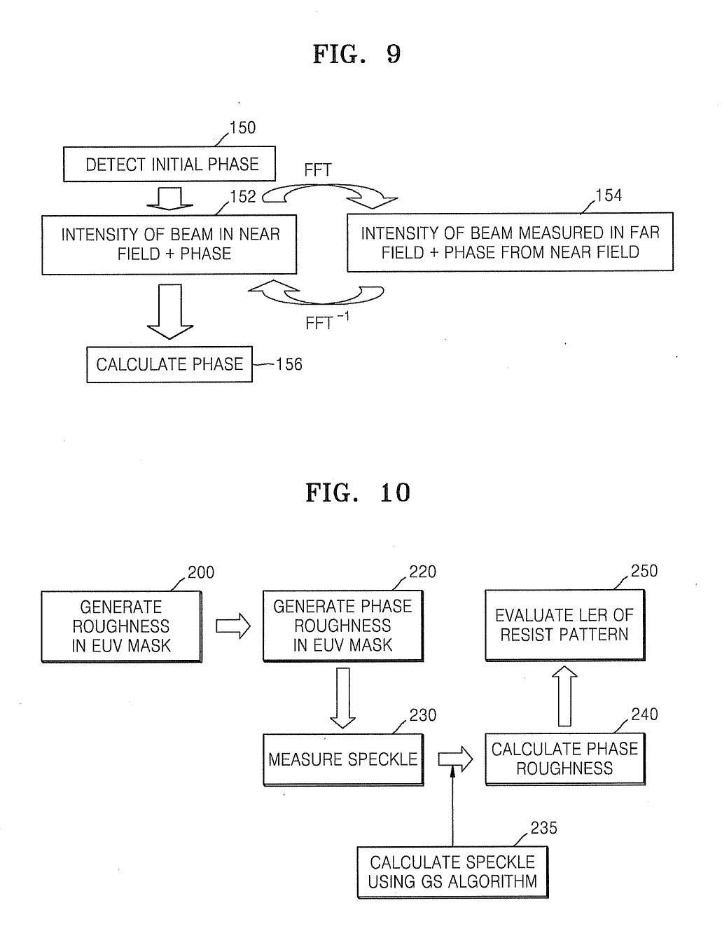

FIG. 9 illustrates a method of calculating phase roughness, according to example embodiments of the inventive concepts.

In more detail, FIG. 9 illustrates a method of calculating phase roughness in an EUV mask by using a speckle measured by the X-ray CCD 132, according to example embodiments of the inventive concepts. The phase roughness in the EUV mask may be calculated by using various types of algorithms but is calculated by using a Gerchberg-Saxton (GS) algorithm in FIG. 9. The GS algorithm will now be described.

In operation 150, an initial phase is assumed or detected. In operation 152, a beam having an arbitrary phase is formed in a near field, for example, of an EUV mask, by using the initial phase and an intensity form of an initially irradiated beam. A form of a beam, which is formed in a far field, for example, on an X-ray CCD, through an advancement of the beam, is calculated by using Fast Fourier Transform (FFT), for example. In operation 154, an intensity of the beam in the far field calculated using FFT is replaced with an intensity of a beam that is measured by the X-ray CCD, and the initial phase is maintained. The process returns to operation 152 to calculate the beam, of which the intensity has been replaced with the measured intensity, as a beam in an EUV mask by using an Inverse FFT.

Operations 152 and 154 are circularly iterated to maintain the initial phase, replace the intensity of the beam with an intensity of a beam measured by the EUV mask and the X-ray CCD, and perform the FFT and inverse FFT. As a result, the initial phase converges to a predetermined/desired phase. In operation 156, among the converging phases, a phase in an EUV mask becomes a value corresponding to phase roughness.

FIG. 10 is a flowchart illustrating a process of evaluating resist LER caused by phase roughness in an EUV mask, according to example embodiments of the inventive concepts.

In operation 200, roughness occurs in an EUV mask in a process of manufacturing the EUV mask. In operation 220, phase roughness occurs in the EUV mask due to the roughness in the EUV mask. As describe above, the phase roughness includes a refractive phase roughness component that is generated by surface roughness of a capping layer and a reflective phase roughness component that is generated by surface roughness of a mask substrate.

In operation 230, a speckle is measured using an apparatus for measuring phase roughness in an EUV mask. In operation 240, the phase roughness is calculated using a GS algorithm as described above. In operation 250, resist LER of a resist pattern, which is caused by the phase roughness in the EUV mask, is calculated and evaluated by using an aerial image simulator.

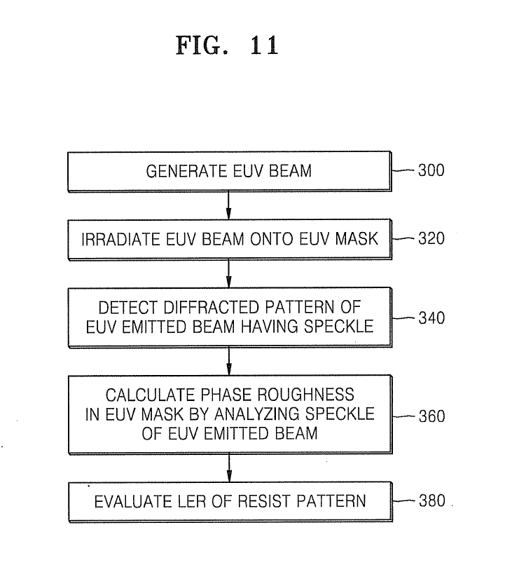

FIG. 11 is a flowchart illustrating a method of measuring phase roughness in an EUV mask, according to example embodiments of the inventive concepts.

In operation 300, an EUV beam is generated. The EUV beam is generated by an apparatus for measuring phase roughness in an EUV mask as described above. The EUV beam is generated by irradiating a femtosecond laser on a neon gas cell.

In operation 320, the EUV beam is irradiated on the EUV mask. The EUV beam irradiated on the EUV mask has a center wavelength of 13.5 nm. In operation 340, a speckle is detected. The speckle is generated by phase roughness in the EUV mask and included in a diffracted pattern of an EUV emitted beam that is diffused and reflected from the EUV mask.

The phase roughness in the EUV mask corresponds to a phase change in an EUV beam caused by surface roughness of the EUV mask. The phase roughness in the EUV mask includes a refractive phase roughness component that is generated by surface roughness of a capping layer of the EUV mask and a reflective phase roughness component that is generated by transferring surface roughness of a mask substrate to a surface of the EUV mask through a reflective layer of the EUV mask.

In operation 360, the phase roughness in the EUV mask is calculated by analyzing the speckle of the EUV emitted beam. The phase roughness in the EUV mask is calculated by using a GS algorithm. In operation 380, a resist LER is calculated and evaluated using the calculated phase roughness. The resist LER is evaluated using an aerial image simulator.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A method of measuring phase roughness in an extreme ultraviolet (EUV) mask, comprising:
irradiating an EUV beam on the EUV mask to detect at least one speckle generated by the phase roughness in the EUV mask; and
determining the phase roughness in the EUV mask based on the detected at least one speckle.

2. The method of claim 1, further comprising:
providing the EUV mask, wherein the phase roughness in the EUV mask is due to a phase change in the EUV beam caused by a surface roughness of the EUV mask.

3. The method of claim 2, further comprising:
providing the EUV mask, wherein the phase roughness in the EUV mask includes a refractive phase roughness component that is generated by a surface roughness of a capping layer included in the EUV mask and a reflective phase roughness component that is generated by a surface roughness of a substrate of the EUV mask.

4. The method of claim 3, further comprising:
providing the EUV mask, wherein the reflective phase roughness component is greater than the refractive phase roughness component.

5. The method of claim 1, wherein determining the phase roughness comprises:
calculating the phase roughness in the EUV mask using a Gerchberg-Saxton (GS) algorithm, the phase roughness being calculated based on the detected at least one speckle.

6. The method of claim 1, wherein the irradiating irradiates the EUV beam at an angle of about 6° with respect to the EUV mask.

7. The method of claim 1, wherein the irradiating irradiates the EUV beam having a center wavelength of about 13.5 nm.

8. The method of claim 1, further comprising:
determining a line edge roughness (LER) of a resist pattern formed on a wafer after determining the phase roughness.

9. A method of measuring phase roughness in an extreme ultraviolet (EUV) mask, comprising:
generating an EUV beam;
irradiating the EUV beam on the EUV mask;
detecting at least one speckle generated by the phase roughness in the EUV mask based on an EUV beam reflected from the EUV mask; and
determining the phase roughness in the EUV mask based on the detected at least one speckle.

10. The method of claim 9, wherein the irradiating irradiates a femtosecond laser on a neon gas cell to obtain the EUV beam.

11. The method of claim 9, wherein the irradiating irradiates the EUV beam having a center wavelength of about 13.5 nm.

12. The method of claim 9, further comprising:
providing the EUV mask including a substrate, a reflective layer formed on the substrate, and a capping layer formed on the reflective layer.

13. The method of claim 12, further comprising:
providing the EUV mask, wherein the phase roughness in the EUV mask includes a refractive phase roughness component that is generated by a surface roughness of the capping layer and a reflective phase roughness component that is generated by a surface roughness of the substrate.

14. The method of claim 9, wherein determining the phase roughness comprises:
calculating the phase roughness in the EUV mask using a Gerchberg-Saxton (GS) algorithm, the phase roughness being calculated based on the detected at least one speckle.

15. The method of claim 9, wherein the irradiating irradiates the EUV beam at an angle of about 6° with respect to the EUV mask.

16-20. (canceled)
